(19) United States
(12) Patent Application Publication
(10) Pub. No.: US 2026/0347123 A1
(43) Pub. Date: Nov. 5, 2026

(54) UNLOADING DEVICE AND METHOD FOR UNLOADING OR LOADING MAIL ITEMS ARRANGED ONE ABOVE THE OTHER

(71) Applicant: KÖRBER SUPPLY CHAIN LOGISTICS GMBH, Konstanz (DE)

(72) Inventor: Peter Enenkel, Konstanz (DE)

(21) Appl. No.: 19/487,795

(22) PCT Filed: May 23, 2024
(86) PCT No.: PCT/EP2024/064268

§ 371 Date: Nov. 25, 2025

(30) Foreign Application Priority Data
May 31, 2023 (DE) 10 2023 114 268.2

(51) Int. Cl. B65G 47/20; B65G 67/24

(52) U.S. Cl. CPC B65G 47/20; B65G 67/24; B65G 2201/0285; B65G 2201/047

(57) ABSTRACT

An unloading device for mail items includes a first transport device for transporting mail items away in a first transport direction, wherein the mail items are arranged on a first plane when the mail items are transported in the first transport direction, and a second transport device for transporting mail items away in a second transport direction, wherein, the mail items are arranged on a second plane when the mail item is transported in the second transport direction, and wherein the first transport device and the second transport device are arranged such that the first plane and the second plane intersect. A related method for unloading or loading mail items arranged one above the other is also provided.

### BACKGROUND OF THE INVENTION

The present invention relates to an unloading device, in particular for mail items, and a method for unloading mail items arranged one above the other.

In distribution centers such as parcel centers, for example, it is common for trucks or the like to be filled with mail items which are arranged one above the other and are to be unloaded. The mail items are unloaded semi-automatically, for example. This means that a conveyor is driven up to an opening in the truck and a worker removes the mail items individually and places them on a transport device such as a conveyor belt.

Due to the usual loading height of trucks of approx. 2.40 m, mail items are stacked correspondingly high inside in order to make optimum use of the transport space. This means that the worker has to remove the mail items at different heights and place them all at the same height, i.e. on the transport device. This can result in high physical strain on the worker. Damage can also occur when unloading the mail items, as this can cause mail items to fall from the upper rows onto the transport device. Furthermore, the long distances that the worker has to cover to reach the transport device can result in a low throughput rate.

It is therefore an object of the present invention to provide a device and a method which, on the one hand, can prevent damage to the mail items during unloading and, on the other hand, can increase the throughput rate of mail items.

### SUMMARY OF THE INVENTION

According to one aspect of the present invention, an unloading device, in particular for mail items, is provided. The unloading device may comprise a first transport device for transporting away mail items in a first transport direction, wherein during a transport of the mail item in the first transport direction, the mail item is arranged on a first plane. Furthermore, the unloading device can comprise a second transport device for transporting away mail items in a second transport direction, wherein the mail item is arranged on a second plane when the mail item is transported in the second transport direction. The first transport device and the second transport device can be arranged such that the first plane and the second plane intersect.

Compared to the known prior art, an unloading device can thus be provided which, in an operating position, has two transport devices arranged vertically one above the other, so that a path which a worker has to cover with a picked-up mail item from the removal position to the deposit position on the transport device is reduced. In other words, especially when unloading mail items from the top row of a truck, a container or a trolley, the distance that has to be covered to deposit the mail item on a transport device can be minimized. The first transport device can therefore also be referred to as the upper transport device. Similarly, the second transport device can be referred to as the lower transport device. This allows mail items to be unloaded efficiently, even if the mail items have a high weight and/or are arranged at different vertical heights.

The unloading device can be arranged between a variable-length conveyor belt and the object to be unloaded. The unloading device can have a receiving side, on which the first transport device and the second transport device are arranged, and a discharge side, on which the first transport device and the second transport device are combined to form a single discharge transport device. This offers the advantage that the unloading device can be connected to any other devices in a distribution center. The transport device can be a device that is designed to transport mail items such as parcels, small packages, bags, etc. The mail items can therefore be piece goods that can be handled individually. The transport device can be, for example, a conveyor belt, a roller conveyor, a chute or any other device that can transport mail items in a transport direction. The first transport device can transport mail items in a first transport direction. In this case, the transported mail item can be arranged on a first plane. In other words, the first transport device can have a transport surface that lies in the first plane. The mail item can be in contact with the transport surface during transport on the first transport device. The same can apply analogously to the second transport device. The first plane and the second plane can be fictitious planes which have an infinite extension in two dimensions. Preferably, the first plane and the second plane intersect, so that the transport surface of the first transport device and the transport surface of the second transport device can be inclined differently relative to each other. This can ensure that at an exit of the unloading device (i.e. at the discharge side of the unloading device), the mail items can be output on only a single transport device (e.g. a collective transport device) and can be further processed using conventional processing devices. Preferably, the first transport device and the second transport device are arranged to overlap in a plan view of the unloading device (in an operating position). As a result, an extension of the unloading device transverse to the first transport device and the second transport device can be reduced. As a result, the unloading device can be easily integrated into existing collection centers without requiring a large amount of additional space. A horizontal component of an extension direction of the first transport direction and the second transport direction can be identical. Furthermore, the first transport direction and the second transport direction can differ in their vertical component of the extension direction. With the above unloading device, it is also possible to efficiently unload stacked mail items, for example from a transport bridge, a truck, a container, a trolley or the like. In particular, outputs of more than 2000 mail items per hour can be achieved. This can increase the overall efficiency of handling the mail items. The first transport device and the second transport device can be arranged one above the other. This can reduce the falling distance of a piece good when it falls out of the stacked piece goods. In other words, the transport devices can be arranged one above the other in the gravity direction. Furthermore, it is therefore not necessary to swivel the transport devices in order to be closer to a piece good in the gravity direction and have to catch it. This means that the transport devices can be designed more simply. Furthermore, at least one of the transport devices can be subdivided. In other words, at least one of the transport devices can have several sections that can move independently of one another. This enables optimum adaptation to the piece goods. Preferably, the transport devices can be individually immobile in a direction transverse to the gravity direction. Of course, the entire unloading device can be moved. However, it is advantageous that the individual transport devices cannot be pivoted independently transverse to the gravity direction. This has the advantage that the transport devices can be designed more simply and there is less wear due to the smaller number of moving parts.

Preferably, the first transport device is designed as a chute. This means that the first transport device can be designed as a passive transport device. In other words, the first transport device can be equipped without any active drive. Mail items that are transported away by the first transport device can be transported by gravity on the first transport device in the first transport direction. Mail items can be additionally or alternatively transported on the first transport device in the first transport direction by means of an initial swing, which is applied to the mail item by a worker, for example. Preferably, the first transport device has a smoother surface than the second transport device. This can ensure smooth passive removal of mail items on the first transport device. Furthermore, by providing a chute as the first transport device, the difference in height (in particular in the vertical direction, i.e. the gravity direction) between the first transport device and the second transport device can be gradually reduced. In other words, a mail item which is placed on the first transport device can be transported in the first transport device to the level of the second transport device at a merging point between the first transport device and the second transport device. This can provide a particularly simple and error-free system. Preferably, only the first transport device is designed as a chute element.

Preferably, the second transport device is designed as a conveyor device. A conveying device can be an actively driven device that can transport mail items away in the second conveying direction by means of an active drive. For example, the second conveyor device can be a belt conveyor, a roller conveyor, a ball conveyor, etc. This ensures that the second conveying device can be arranged as close to the floor as possible so that mail items that are to be unloaded or loaded do not have to be lifted far against the gravity direction in order to be placed on the second conveying device. This can reduce the physical strain on a worker. Furthermore, an actively driven conveyor device can ensure that the second conveyor device can convey along an ascending conveyor section (i.e. along the second conveying direction). This makes it even easier to adapt the unloading device to existing facilities in collection centers. This can increase the usability of the unloading device. Preferably, only the second transport device is designed as a conveyor device.

Preferably, the first transport device has a first section and a second section, wherein the first section is displaceable between a first position and a second position. The first transport device can be divided into a first section and a second section along the first transport direction. In other words, the first section and the second section can adjoin each other in the transport direction. Due to the displaceability of the first section between a first position of a second position, an extension of the first transport device in the first transport direction can be variable. In other words, the extension of the first transport device in the first transport direction can be shortened or lengthened, depending on whether the first section is in the first position or the second position. In the first position, for example, the first section can be folded out so that the first transport device has its maximum length in the first transport direction. In the second position, for example, the first section can be folded in so that the first transport device has a shortened length in the first transport direction. This offers the advantage that when a worker wants to unload the top row of mail items from a container, the first section can be in the first position (i.e. in the unfolded position) so that the worker can easily deposit the mail items from the top row onto the first transport device. This ensures a minimum distance between the point of origin of the mail items and the place where the mail items are deposited. If the worker then wants to unload an underlying row of mail items, the first section of the first transport device can be displaced to the second position (i.e. to the folded position) so that the worker can easily reach the next row of mail items in order to displace them to the second transport device. This can also ensure a better range of movement for the worker between the unloading device and the mail items to be unloaded.

Preferably, the first section is rotatable about an axis of rotation during a displacement between the first position and the second position. The first section can be hinged about the axis of rotation when displaced between the first position and the second position. This makes it particularly easy to move the first section back and forth between the first position and the second position. In the second position, the first section can rest on the second section. In other words, in the second position, the second section can serve as a stop for the first section. The first position may be defined by a stop. The first position and the second position may be the only stable positions to which the first portion is movable. In other words, at positions between the first position and the second position, the first section can fall (e.g. gravity-driven) into either the first position or the second position without requiring any action. This can ensure particularly easy operation of the unloading device. Furthermore, a simple push of the first section by a worker can bring the first section into the first position or the second position. This can speed up the work process.

Preferably, the first section and/or the second section is/are elastically designed and/or arranged. By providing elasticity in the first section, the placement of a mail item on the first section can be cushioned or sprung. This can also ensure that the mail items are not damaged. An elastic design can be realized, for example, by selecting a material for the first section. For example, the first section can be formed from an elastically deformable material. For example, the first section can be formed from a plastic material. Furthermore, the first section can be geometrically designed in such a way that it has elasticity. For this purpose, the first section can have a tapered shape (e.g. against the first transport direction). The arrangement of the first section can, for example, be realized as a cantilever arm. In other words, the first section can be supported at an outer end thereof. As a result, elasticity can be achieved by arranging the first section. This can ensure particularly gentle handling of mail items.

Preferably, the first section is arranged on the second section in the second position. In the first position, the first section and the second section can form a transport surface which lies in the first plane. In the second position, a transport surface formed by the first section and the second section can lie in the first plane by the first section resting on the second section. In other words, the first section can be folded over onto the second section so that a transport surface of the first section defined by the first section comes to rest directly on a transport surface of the second section. The mail items can then be transported away on a transport surface formed by a rear surface (opposite the transport surface of the first section) of the first section. In addition, the transport surface formed in the second position can be formed by the rear surface of the first section and the top surface of the second section. Thus, the first section can also be part of the first plane in the folded-down position (i.e. in the second position) and provide for transporting away the mail items. In this case, the first plane can have a step. This means that it is not necessary to completely fold away or remove the first section so that it is no longer in the way, which would require more space. The above solution can provide a compact unloading device.

Preferably, the first section is pivoted by at least 175° during a displacement between the first position and the second position. The pivoting of the first section by at least 175° ensures that mail items on a rear surface of the first section can still be easily transported away by the first transport device in the first transport direction. If the pivoting were less wide, there would be a risk that mail items would remain on the then pivoted first section, without being transported away by the first transport device. Preferably, the first section is pivoted by 180°. In other words, the first section can provide a transport surface in the first position as well as in the second position, which lies in the first plane. This can ensure that both in the first position and in the second position, the mail items are transported continuously in the first transport direction

Preferably, the first section has a first end and a second end, wherein the first section has a shape that tapers in cross-section towards the first end. The first end of the first section can protrude from the first transport device. The second end of the first section may face the second section. Preferably, the second end of the first section is in direct contact with the second section. Preferably, the first section is arranged in a cantilever-like manner on the first transport device. In this case, the second end of the first section can be fixed to the first transport device. A tapered shape of the first section in the direction of the first end can reduce the weight force generated by the dead weight of the first section. As a result, a lever arm on the fastening of the first section can be reduced. This can ensure the durability of the unloading device. Furthermore, an elastic effect can be achieved by tapering so that the first section has a resilient property, which is advantageous when mail items are placed on the first section. The tapered shape can be achieved by reducing the material thickness of the first section. In particular, the material thickness can be reduced in a gravity direction (in the operating position of the unloading device) in the direction of the first end. Preferably, the first section can have a substantially triangular shape in cross-section (the cross-section can be orthogonal to the first and second plane).

Preferably, the second section has a curved shape in cross-section. The second section may have a first end and a second end. The first end of the second section may face the first section. In particular, the first end of the second section may be in direct contact with the first section. The second end of the second section may face the second transport device. The second section can be arranged in a cantilever-like manner on the first transport device. In particular, the second section can be arranged with the first end of the second section on the first transport device. The second end of the first section and the first end of the second section can be fixed to the same attachment point on the first transport device. This allows the first transport device to be simpler overall. The curved shape of the second section can ensure that the first section can be easily displaced from the first position to the second position. More precisely, the second section can be curved starting from the first end of the second section and then extend straight to the second end of the second section in the first transport direction. This can form a transport surface of the second section, which can be parallel to a transport surface of the first section (in the first position) and offset from the transport surface of the first section. This ensures that the first section can be easily shifted onto the second section in the second position. In other words, the curved shape of the second section can form a receiving space in which the first section can come to rest in the second position. This can provide a particularly simple and compact system.

Preferably, the unloading device further comprises a weight force compensation element which is designed to hold the first section and/or the second section so that a weight force is at least partially compensated. The weight force compensation element can thus at least partially absorb a weight force caused by the first section and/or the second section. In addition to the dead weight of the first section and the second section, the weight of a mail item that is transported away on the first section and/or the second section can also be absorbed by the weight force compensation element. As a result, in addition to the fastening of the first section and/or the second section, a further element can be provided which can reduce the weight force on the fastening position of the first transport device. The weight force composition element can comprise a spring, for example. Preferably, the weight force compensation element is designed as a spiral spring or roller spring. Furthermore, the weight force compensation element can also be designed as a damping element, which is in contact with the first section and/or the second section. As a result, peak loads on the first transport device (for example due to the application of particularly heavy mail items) can be absorbed without these being fully introduced into the fastening of the first section and/or the second section.

Preferably, the weight force separation element is arranged in the axis of rotation. The axis of rotation may be the axis about which the first section is rotated when the first section is displaced from the first position to the second position. By providing the weight force compensation element in the axis of rotation, a particularly compact design can be achieved. Furthermore, this can further increase the elastic effect of the first section. If the weight force compensation element is provided in the axis of rotation, it is particularly preferable that the weight force compensation element is designed as a spiral spring or roller spring. This allows a particularly simple design of the first transport device to be realized.

Preferably, the first section and the second section are arranged at the same attachment point on the first transport device. The attachment point can be a position at which both the first section and the second section are supported. Preferably, the first transport device comprises a frame on which the attachment point is arranged. Thus, the first section and the second section may be fixed to the frame of the first transport device. Preferably, the first section and the second section are fixed exclusively to the attachment point. As a result, on the one hand, a particularly simply designed first transport device can be provided and, on the other hand, both the first section and the second section can be supported in a cantilever-like manner. This can provide a certain degree of elasticity. This allows the mail items to be handled particularly gently by the first transport device. The first section can exhibit elasticity when the mail items are placed on it. The second section can exhibit elasticity when the mail items are deposited and when other mail items pass on the second transport device (further details are provided below). Furthermore, by fastening the first section and the second section to the same attachment point, the first transport device can be particularly easily adjusted in height (i.e. vertical height).

Preferably, the axis of rotation runs through the attachment point. The axis of rotation can be the axis about which the first section can be displaced from the first position to the second position. By having the axis of rotation pass through the attachment point of the first section and the second section, a particularly simple system can be provided that provides the least possible elasticity at the rotation point, but can provide elasticity and/or flexibility at the outer ends of the first section and the second section (i.e. at the first end of the first section in the second end of the second section).

Preferably, the first transport device comprises a first section and a second section, wherein the first section comprises at least two segments that are independently displaceable between the first position and the second position. In other words, the first section may be divided into a plurality of sub-sections (i.e. segments). The individual segments may together form the first section. This offers the advantage that the first section can also be only partially displaced, for example from the first position to the second position. In other words, a part of the first section can be arranged in the first position, whereas another part of the first section can be arranged in the second position. In this way, the first section can be adapted even better to a stack of mail items to be unloaded. Furthermore, the working space of a worker adjacent to the first section can be individually adjusted. As a result, it can be advantageously adapted depending on a dimension of the mail items (for example, there may be a large number of mail items of different sizes). Furthermore, a worker can move back and forth between the unloading device and the stack of piece goods to be unloaded, either completely or partially, since the first section does not have to be displaced all at once (i.e. moved from the first position to the second position), but can be displaced successively (i.e. one after the other). This can shorten the distances that mail items have to travel from the stack to the first transport device. This can increase the efficiency of using the unloading device. For example, three segments can be provided. However, it is also conceivable that more segments can be provided.

Preferably, the at least two segments are individually rotatable about an axis of rotation, so that at least one of the segments can be displaced between the first position and the second position. The individual and independent displaceability of each of the segments means that they can be easily adapted to the stack of mail items at hand. The axis of rotation about which the individual segments are rotatable in order to be displaced between the first position in the second position can be the same axis of rotation as in the embodiments described above. Preferably, the first section has three segments. With three segments, it has been found that with the usual width of transport equipment in a mail item handling system, sufficient subdivision can be achieved by the first section to optimally adapt the first section to the stack of mail items. Preferably, the three segments have the same width in a direction orthogonal to the first transport direction and parallel to the first plane. In other words, the first section can be divided into segments of the same width. This makes it easier for the worker to operate the unloading device, since each segment can be loaded with mail items in the same way.

In a further embodiment, the individual segments have a different width transverse to the first transport direction and parallel to the first plane. This allows individual adaptation to mail items to be achieved. For example, when unloading a large number of relatively small mail items or (such as smalls or the like), it may be advantageous to provide extra segments intended for this purpose, as these are lighter and allow even more precise adaptation to the mail items. In this way, a worker can get as close as possible to the stack of mail items and still have a minimum distance between the stack of mail items and the first unloading device.

Preferably, the unloading device also comprises a damping element which is designed to storage the first transport device in a sprung and/or damped manner. Springing can mean that the first transport direction yields to an external load and returns to its original position once the external load is removed. In this way, for example, an impact can be cushioned (i.e. reduced) when a mail item hits the first transport device. In the present case, damping can be defined as a property that reduces mechanical oscillations (such as vibration, shocks, impacts, etc.). Oscillations can also be interpreted as kinetic energy. The damping property can then convert such kinetic energy into thermal energy. As a result, a load acting on the first transport device can be reduced. This can increase the durability of the first transport device. The damping element, which is designed to damp the first transport device, can be designed as an oscillation carrier, for example. Furthermore, a damping element can prevent the system from oscillating. This is particularly advantageous if the first and/or second section is designed as a cantilever arm. Overall, the damping element can increase the durability of the unloading device. Furthermore, noise generation during operation of the unloading device can be reduced.

Preferably, the first transport device is spaced apart from the second transport device. In other words, the first transport device cannot contact the second transport device. Friction can thus be avoided. Furthermore, one of the transport devices can be an actively driven transport device (preferably the second transport device) and thus damage the first transport device if it comes into contact with it. It is therefore advantageous if the first transport device and the second transport device are arranged on the unloading device in such a way that they are spaced apart.

Preferably, the first transport device has a first section and a second section, wherein the second section is displaceable between a normal position and a deflection position. The second section of the first transport device can be designed to feed mail items, which are transported away from the first section of the first transport device in the first transport direction, to the second transport unit. It is therefore expedient if the second section of the first transport device is located in the vicinity of the second transport device. However, this can lead to problems if mail items are transported away on the second transport unit in the second transport direction. More precisely, if the second section of the first transport device is arranged too close to the second transport device, mail items transported on the second transport device may become jammed under the second section of the first transport device and thus block the second transport device. The fact that the second section of the first transport device can be displaced between the normal position and the deflection position means that this can be taken into account by allowing a mail item being transported on the second transport device in the second transport direction to deflect the second section from the normal position towards the deflection position. This can ensure that a mail item being transported on the second transport unit can easily pass through the second section of the first transport device. The normal position can represent a position in which the second section is arranged in the first plane. The deflection position can represent a position that is further away from the second transport unit compared to the normal position. This means that the second transport unit can be provided with more space to transport mail items away on it. For example, the second section can be articulated and can be moved passively by a mail item that is being transported on the second transport unit in the second transport direction. This allows the second section to move exactly as far away from the normal position as is required so that a mail item can be easily transported away on the second transport device. This can create an efficient and simple system. Furthermore, the requirement to arrange the second section as close as possible to the second transport unit can be met, so that falling of mail items from the second section onto the second transport unit can be avoided. The first section and the second section may be the same section as in the above embodiment.

Preferably, the second section is passively displaceable between the normal position and the deflection position. As already described above, the second section can be moved from the normal position to a deflected position without active actuation by a servomotor or an actuator or the like. Furthermore, the second section can fall back into the normal position from the deflected position, driven by gravity. This ensures individual adjustment of the deflection of the second section of the first transport device.

Preferably, the second section is rotated about an axis of rotation during a displacement between the normal position and the deflection position. The axis of rotation may be the same axis of rotation as in the above embodiments. In other words, the second section can be designed as a cantilever arm. As a result, when the second section is pressurized in the vicinity of the second end of the second section, the second section can be easily deflected.

Preferably, the second section is designed and arranged in such a way that it returns automatically from the deflected position to the normal position. The normal position can, for example, be defined by a stop. In other words, the second section cannot be moved closer to the second transport device beyond the normal position. The normal position thus represents a position that corresponds to the closest possible approach between the second section and the second transport device. The second section can, for example, fall back from the deflected position into the normal position due to its own weight. Additionally or alternatively, a spring element or the like can also be arranged for this purpose, which always pushes the second section back into the normal position. This can again provide a system that is particularly easy to control and less prone to errors.

Preferably, the second transport device is inclined relative to a horizontal. In this way, the unloading device can provide a connection between a position of the container to be unloaded close to the floor and a transport system present in the processing system. In other words, it is advantageous if a worker has to lift mail items in as few opposing heavy directions as possible. It therefore makes work easier if the second transport unit is arranged as close to the floor as possible. However, systems provided in existing installations, such as a variable-length conveyor, which is used in the prior art for unloading transport bridges, require a certain height so that the length variability can be provided. However, the second transport device of the present unloading device can be provided almost flush with the floor, since the second transport device cannot have any other functionalities such as length variability. However, in order to integrate the unloading device into existing transport systems without any problems, the second transport unit can be inclined relative to the horizontal and the mail items transported on it can be brought to a normal transport plane of the respective handling system. This makes it particularly easy to integrate the unloading device into existing handling centers.

Preferably, the first transport device and the second transport device are connected by a frame, wherein the frame has a damping element. The damping element can be the damping element described above. The frame may, for example, be a steel and/or aluminum structure which may form part of the unloading device. The frame may hold the first transport unit and the second transport unit. Furthermore, the frame can comprise a base frame that has transport rollers. The transport rollers can be used to move the unloading device to any desired location. The frame can have a connection between the first conveyor unit and the second conveyor unit. The connection can be connected at its first end to the first transport device and at its second end to the second transport device. The connection can be inclined relative to the horizontal and relative to the vertical. As a result, a damping element can be appropriately fitted between the connection and another fixed frame element. This can provide a satisfactory damping and/or spring effect of the damping element.

Preferably, the unloading device has bidirectional rollers so that the unloading device can be moved anywhere in the room. This ensures that the unloading device can be optimally adapted to existing systems. Furthermore, particularly wide storage devices for mail items can also be unloaded without any problems.

Preferably, the first section and the second section are arranged in the same fastening position on the frame. This allows a particularly efficient error or damping system to be realized.

Preferably, the second transport device is designed so that an inclination of the second transport device can be adjusted. This allows the unloading device to be adapted even better to existing systems.

According to a further aspect of the present invention, a method for unloading or loading mail items arranged one above the other is provided. The method may comprise providing an unloading device. The unloading device may comprise a first transport device for transporting mail items away in a first transport direction. When transporting the mail item in the first transport direction, the mail item may be arranged on a first plane. The unloading device may comprise a second transport device for transporting mail items away in a second transport direction. When transporting the mail item in the second transport direction, the mail item can be arranged on a second plane. The first transport device and the second transport direction may be arranged such that the first plane and the second plane intersect. The method may further comprise placing a mail item on the first transport device or the second transport device. Further, the method may comprise transporting the mail items away on a collective transport device that can receive mail items from the first transport device of the second transport direction. The collective transport device may, for example, be a transport device already provided in a mail item processing system, onto which the mail items to be unloaded are to be transported.

Individual features and embodiments can be combined with each other to form new embodiments. Advantages and embodiments of the features and embodiments then also apply analogously to the new embodiments. Advantages and embodiments mentioned in connection with the device also apply analogously to the method and vice versa.

### BRIEF DESCRIPTION OF THE DRAWINGS

In the following, the present invention is described in detail with reference to the attached figures.

FIG. 1 shows a schematic sectional view of an unloading device according to one embodiment of the present invention.

FIG. 2 shows nine steps ((a) to (j)) in the unloading of mail items using an unloading device according to one embodiment of the present invention.

### DETAILED DESCRIPTION OF THE PREFERRED EMBODIMENTS

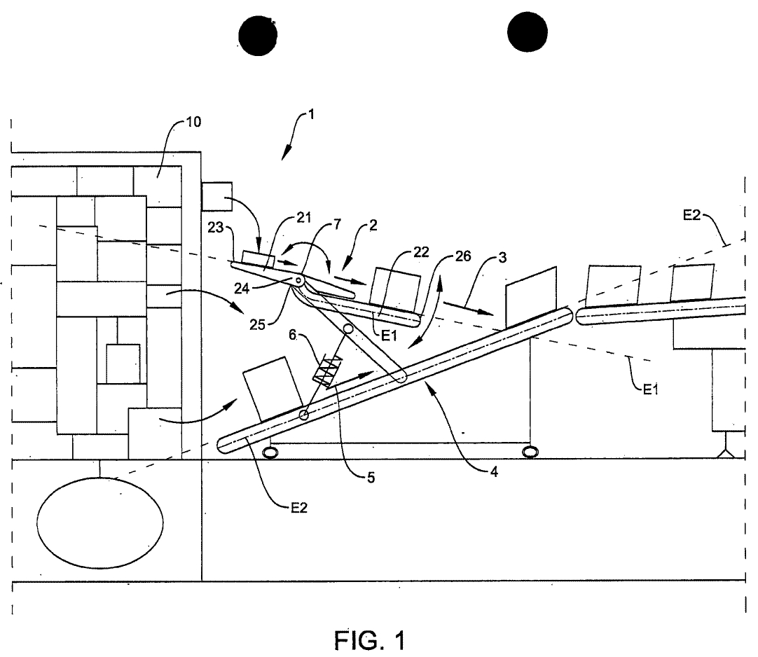

FIG. 1 is a schematic view of an unloading device 1 according to one embodiment of the present invention. The unloading device 1 comprises a first transport device 2 for transporting mail items away in a first transport direction 3. Furthermore, the unloading device 1 comprises a second transport device 4 for transporting mail items 10 away in a second transport direction 5. If a mail item 10 is transported away by the first transport device 2 in the first transport direction 3, the mail item 10 rests on a first plane E1. If a mail item 10 is transported away by the second transport device 4 in the second transport direction 5, the mail item 10 rests on a second plane E2. In FIG. 1, the planes E1, E2 are shown as dashed lines. The planes extend into the plane of the figure. On the left-hand side of FIG. 1, a part of a truck to be unloaded is shown schematically. The truck has a large number of mail items 10 of different sizes in its loading space. The first transport device 2 and the second transport device 4 are arranged so that the two planes E1, E2 intersect. In other words, the transport directions 3 and 5 are inclined so that they intersect. The first transport device 2 is designed as a chute element. This means that the mail items 10 can be transported away passively on the first transport device 2. The second transport device 4 is designed as a belt conveyor. The second transport device 4 therefore actively transports the mail items 10. This means that when mail items 10 are transported on the second transport device 4, the mail items can also overcome a height in the gravity direction. In other words, the second transport device 4 is inclined so that mail items 10 can be transported upwards relative to the gravity direction, whereas the first transport device 2 is inclined so that the mail items can be transported on it by gravity.

The first transport device 2 has a first section 21 and a second section 22. The sections 21, 22 together form the transport device 2 and are each designed as a chute element. The first section 21 has a first end 23 of the first section 21 and a second end 24 of the first section 21. The second section has a first end 25 of the second section 22 and a second end 26 of the second section 22. The first section 21 and the second section 22 are connected to each other by the second end 24 of the first section 21 and the first end 25 of the second section 22. The first section 21 can be moved from a first position to a second position (see double arrow in FIG. 1). In the first position, the first section forms an extension of the second section 22. In the second position, the first section 21 rests on the second section 22. Thus, the first transport unit 2 can be designed with variable lengths. Furthermore, the unloading device 1 of the present embodiment has a damping element 6, which is designed to storage the first transport unit 2 in a damped and/or sprung manner. In other words, the first transport device 2 can be designed as a foldable chute. The second section 22 can also be designed to be movable about the rotation point 7. The second section 22 can be movable between a normal position and a deflected position (see double arrow in FIG. 1 on the second section 22). In FIG. 1, the second section 22 is shown in the normal position. Thus, when a mail item 10 is transported on the second transport device 4 in the second transport direction 5, the second section 22 can be pushed away by the mail item 10 against the gravity direction so that the mail item 10 can easily pass through the second section.

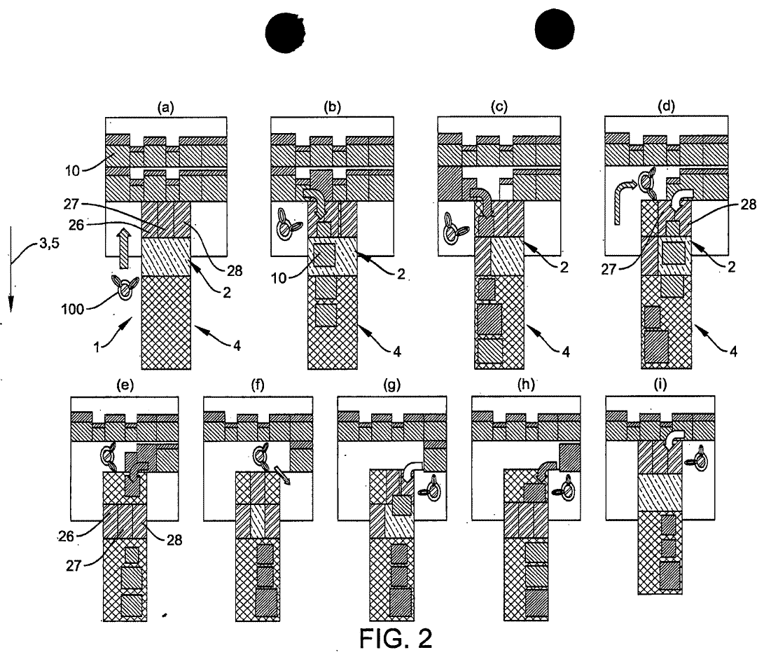

FIG. 2 shows a large number of working positions a) to i), which are passed through by the unloading device 1. The illustrations each show the unloading device 1 and a plurality of mail items 10 in a top view.

In the first illustration a), the unloading device 1 is approaching to a stack of mail items 10 of different sizes (see arrow in FIG. 2). The mail items 10 to be unloaded are of different sizes. The approach can take place automatically or by a user 100.

In the second illustration b), the mail items 10 in the top row are placed on the unloading device 1 in the left-hand quadrant and in the center. In particular, the mail items are placed on the first transport device 2. Due to the proximity of the first transport device 2 to the mail items 10, the mail items 10 can be applied to the first transport device 2 by tilting and/or pushing in the simplest manner. Thus, the upper row in the left quadrant can be completely unloaded.

In the third illustration c), it can be seen that the first transport device 2, in particular the first section 21 of the first transport unit 2, has three segments (first segment 26, second segment 27, third segment 28). In the third illustration c), it can be seen that the first segment 26 is transferred from the first position to the second position. In other words, the first segment 26 is folded onto the second section 22. As a result, the second transport device 4 is now easily accessible for the worker 100. Now the mail items 10 of the bottom row in the left-hand section are placed on the second transport device 4. This allows the bottom row in the left-hand quadrant to be completely unloaded.

In the fourth illustration d), it can be seen that the worker 100 can reach directly in front of the unloading device 1 via the resulting free space and can apply the upper row in the right-hand quadrant onto the second segment 27 and the third segment 28. The second segment 27 and the third segment 28 are still in the first position and thus in close proximity to the mail items 10 of the top row in the right-hand quadrant. This means that the mail items 10 can again be unloaded easily by tilting and/or pushing.

In the fifth illustration e), all segments 26, 27, 28 are in the second position (i.e. folded over) so that the worker 100 can place the mail items on the second transport device 4.

In the sixth illustration f), the worker folds the second segment 27 back into the first position and now simply moves to the right of the unloading device 1.

In the seventh illustration g), the worker folds the third segment 28 from the side of the unloading device back into the first position in order to then unload the uppermost mail items 10 in the upper right quadrant.

Once the top row in the right-hand quadrant has been unloaded, the worker 100 can fold down all the segments 26, 27, 28, as shown in the eighth illustration h), so that the second transport device 4 is exposed over its full width. The worker 100 can then easily apply the bottom row of mail items 10 in the right-hand quadrant onto the second transport device 4 by tilting and/or pushing. Thus, the first row of mail items 100 is unloaded with minimal effort.

In the ninth illustration i), it can be seen that the unloading device 1 is returned to the starting position shown in the first illustration a) with respect to the subsequent stack of mail items 10 and the process described above is run through again.

### LIST OF REFERENCE SIGNS

1 Unloading device
2 First transport device
3 First transport direction
4 Second transport device
5 Second transport direction
6 Damping element
7 Axis of rotation
10 Mail items
21 First section
22 Second section
23 First end of the first section
24 Second end of the first section
25 First end of the second section
26 Second end of the second section
E1 First plane
E2 Second plane
26 First segment
27 Second segment
28 Third segment
100 User

1-28. (canceled)

29. An unloading device, comprising:
a first transport device for transporting mail items away in a first transport direction, wherein the mail items are arranged on a first plane when the mail items are transported in the first transport direction; and
a second transport device for transporting mail items away in a second transport direction, wherein the mail items are arranged on a second plane when the mail items are transported in the second transport direction;
wherein the first transport device and the second transport device are arranged such that the first plane and the second plane intersect.

30. The unloading device according to claim 29, wherein the first transport device is configured as a chute.

31. The unloading device according to claim 29, wherein the second transport device is configured as a conveyor device.

32. The unloading device according to claim 29, wherein the first transport device has a first section and a second section, wherein the first section is displaceable between a first position and a second position.

33. The unloading device according to claim 32, wherein the first section is rotatable about an axis of rotation when displaced between the first position and the second position.

34. The unloading device according to claim 32, wherein the first section and/or the second section is elastically configured and/or arranged.

35. The unloading device according to claim 32, wherein the first section is arranged in the second position on the second section.

36. The unloading device according to claim 32, wherein the first section is pivoted by at least 175° during a displacement between the first position of the second position.

37. The unloading device according to claim 32, wherein the first section has a first end and a second end, wherein the first section has a shape tapering in cross-section towards the first end.

38. The unloading device according to claim 32, wherein the second section has a curved shape in cross-section.

39. The unloading device according to claim 32, further comprising:
a weight force compensating element configured to hold the first section and/or the second section so that a weight force is at least partially compensated.

40. The unloading device according to claim 39, wherein the weight force separation element is arranged in the axis of rotation.

41. The unloading device according to claim 40, wherein the axis of rotation extends through the attachment point.

42. The unloading device according to claim 32, wherein the first section and the second section are arranged at the same attachment point on the first transport device.

43. The unloading device according to claim 29, wherein the first transport device has a first section and a second section, wherein the first section has at least two segments which are displaceable independently of each other between a first position and a second position.

44. The unloading device according to claim 43, wherein the at least two segments are individually rotatable about an axis of rotation so that at least one of the segments is displaceable between the first position and the second position.

45. The unloading device according to claim 44, wherein, wherein the individual segments have a different width transverse to the first transport direction and parallel to the first plane.

46. The unloading device according to claim 29, further comprising:
a damping element configured to support the first transport device in a sprung and/or damped manner.

47. The unloading device according to claim 29, wherein the first transport device is spaced apart from the second transport device.

48. The unloading device according to claim 29, wherein the first transport device has a first section and a second section, wherein the second section is displaceable between a normal position and a deflected position.

49. The unloading device according to claim 48, wherein the second section is passively displaceable between the normal position and the deflected position.

50. The unloading device according to claim 48, wherein the second section is rotated about an axis of rotation during a displacement between the normal position and the deflected position.

51. The unloading device according to claim 48, wherein the second section is designed and arranged to return automatically from the deflected position to the normal position.

52. The unloading device according to claim 48, wherein the second transport device is inclined relative to a horizontal.

53. The unloading device according to claim 29, wherein the first transport device and the second transport device are connected by a frame, wherein the frame has a damping element.

54. The unloading device according to claim 29, wherein the unloading device has bidirectional rollers, so that the unloading device can be displaced in space as desired.

55. The unloading device according to claim 29, wherein the first section and the second section of the same attachment position are arranged on the frame.

56. The unloading device according to claim 29, wherein the second transport device is configured such that an inclination of the second transport device is adjustable.

57. A method for unloading or loading mail items arranged one above the other, comprising:
providing an unloading device comprising a first transport device for transporting mail items away in a first transport direction, wherein the mail items are arranged on a first plane when the mail items are transported in the first transport direction, and a second transport device for transporting mail items away in a second transport direction, wherein the mail items are arranged on a second plane when the mail items are transported in the second transport direction, wherein the first transport device and the second transport device are arranged such that the first plane and the second plane intersect;
placing a mail item on the first transport device or the second transport device; and
transporting the mail item away to a collective transport device configured to receive mail items from the first transport device and the second transport device.
